(19) United States
(12) Patent Application Publication
(10) Pub. No.: US 2013/0314053 A1
(43) Pub. Date: Nov. 28, 2013

(54) BATTERY MANAGEMENT UNIT

(71) Applicant: SANYO Electric Co., Ltd., Osaka (JP)

(72) Inventor: Toshiya IWASAKI, Osaka (JP)

(73) Assignee: SANYO Electric Co., Ltd., Osaka (JP)

(21) Appl. No.: 13/956,113

(22) Filed: Jul. 31, 2013

Related U.S. Application Data
(63) Continuation of application No. PCT/JP2012/066226, filed on Jun. 26, 2012.

(30) Foreign Application Priority Data
Jul. 12, 2011 (JP) 2011-153919

(51) Int. Cl. H02J 7/00

(52) U.S. Cl. CPC H02J 7/0052
USPC 320/162

(57) ABSTRACT

A charging system (10) is constituted by including a battery assembly (14) constituted by a plurality of storage batteries (12), a switching unit (16), a charging control unit (18), and a battery management unit (20). The battery management unit (20) is equipped with: a voltage acquiring section (22) for acquiring a terminal-to-terminal voltage (V_{B}) of the battery assembly (14) on which constant current charging is being performed under the control of the charging control unit (18); and a transmission processing section (24) for, when the acquired terminal-to-terminal voltage (V_{B}) of the battery assembly (14) reaches a predetermined threshold switching voltage (V₀), transmitting a switching command for prompting the charging control unit (18) to switch from constant current charging to constant voltage charging.

### CROSS-REFERENCE TO RELATED APPLICATION

The present application is a continuation application of International Application No. PCT/JP2012/066226, filed Jun. 26, 2012, the entire contents of which are incorporated herein by reference and priority to which is hereby claimed. The PCT/JP2012/066226 application claimed the benefit of the date of the earlier filed Japanese Patent Application No. 2011-153919 filed Jul. 12, 2011, the entire content of which is incorporated herein by reference, and priority to which is hereby claimed.

### TECHNICAL FIELD

The present invention generally relates to a battery management unit which can monitor a terminal-to-terminal voltage of a storage battery, and more particular to a battery management unit which can monitor a terminal-to-terminal voltage of a storage battery when charging the storage battery.

### BACKGROUND ART

A storage battery is a secondary battery that is rechargeable. However, in order to utilize the power storage capacity thereof as much as possible, charging is preferably performed up to a charge limit, and the power having been charged up to the maximum is discharged for use. With charging to the charge limit referred to as full charge, a charging method is preferred which can attain full charge in as short a time as possible.

Patent Literature 1, for example, describes, as a charging method for a storage battery, a method in which constant current charging is performed according to a current set value, and when a battery voltage reaches a voltage set value, constant current charging is switched to constant voltage charging is performed.

### CITATION LIST

### Patent Literature

PATENT LITERATURE 1: Japanese Patent Laid-Open Publication No. 2002-152984

### SUMMARY OF INVENTION

### Technical Problem

In a case where the method described in Patent Literature 1 is used, appropriate constant current charging is performed first, and once the charging reaches a threshold switching voltage which is close to full charge, switching to constant voltage charging that holds the threshold switching voltage is performed. Since switching is performed by a charging control unit that controls a charging current supplied to a storage battery, it is convenient that the threshold switching voltage is compared with the voltage of a storage battery on the charging control unit side.

However, for example, if a case is assumed in which an element such as a switch is disposed between the charging control unit and the storage battery, a voltage drop that cannot be ignored may occur at the element such as the switch. That is, even if an on-resistance of the switch is a low resistance value, when a current at the time of the constant current charging is a large current, the large current flows to the element such as the switch, thereby causing a voltage drop that cannot be ignored. Accordingly, in a case where a voltage of the element such as the switch on the charging control unit side is used to be compared with the threshold switching voltage, for switching to the constant voltage charging, a switching is performed at the time at which a terminal-to-terminal voltage of the storage battery is still in a state before reaching a threshold switching voltage, resulting in an extra time before reaching full charge.

It is an advantage of the present invention to provide a battery management unit capable of providing an appropriate time for switching from constant current charging to constant voltage charging.

### Solution to Problem

A battery management unit according to the present invention comprises: a voltage acquiring section for acquiring a terminal-to-terminal voltage of a storage battery in which constant current charging is being performed under control from a charging control unit; and a transmission processing section for, when an acquired terminal-to-terminal voltage of the storage battery reaches a predetermined threshold switching voltage, transmitting a switching command for prompting the charging control unit to switch from the constant current charging to constant voltage charging.

### Advantageous Effect of Invention

According to the present invention, an appropriate time is provided for switching from the constant current charging to the constant voltage charging.

### BRIEF DESCRIPTION OF DRAWINGS

FIG. 1 is a diagram for explaining a configuration of a charging system in which a battery management unit is used according to an embodiment of the present invention.

FIG. 2 is a set of graphs for explaining a state in which constant current charging is switched to constant voltage charging.

FIG. 3 is a flow chart showing a charging procedure performed when the battery management unit is used according to the embodiment of the present invention.

FIG. 4 is a flow chart showing a charging procedure which is different from FIG. 3.

### DESCRIPTION OF EMBODIMENT

In the following, an embodiment according to the present invention will be described in detail with reference to the drawings. In the following, a lithium ion battery will be described as a storage battery, but a storage battery other than the lithium ion battery may be used. For example, a nickel hydrogen battery, a nickel cadmium battery, or the like may be used. In the following, a case of charging a battery assembly, in which a plurality of storage batteries are connected in series for obtaining an appropriate terminal-to-terminal voltage and an appropriate charging capacity is described, but a single storage battery may be charged as a matter of course. Further, the battery assembly may be constituted with a plurality of storage batteries connected in parallel, or, the battery assembly may be constituted with a plurality of batteries connected in series/parallel combination. The terminal-to-terminal voltage of a battery assembly or the terminal-to-terminal voltage of a storage battery described in the following is an example for description, and may be changed as appropriate according to specification of the battery assembly.

In the following, similar elements are denoted with the same numeral or character in all drawings, for omitting duplication in description. In addition, in description of the present specification, the numeral or character used before then will be used as appropriate.

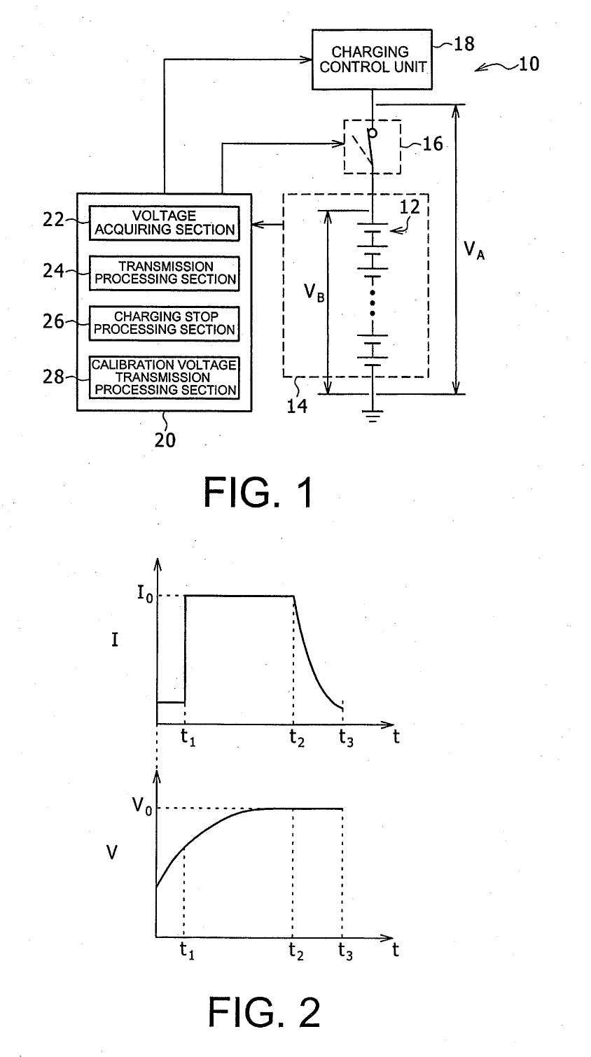

FIG. 1 is a diagram for showing a configuration of a charging system 10 in which a battery management unit 20 is used. The charging system 10 is constituted by including a battery assembly 14 in which a plurality of storage batteries 12 are connected in series, a switching unit 16, a charging control unit 18, and a battery management unit 20. The charging system 10 is a system which uses a terminal-to-terminal voltage V_{B} of the battery assembly 14 that is acquired by the battery management unit 20 to appropriately full-charge the battery assembly 14.

The battery assembly 14 is constituted by connecting a plurality of storage batteries 12 in series to obtain a desired terminal-to-terminal voltage V_{B} and a charging capacity. Here, the storage battery 12 to be used is a battery in which a plurality of lithium ion unit storage batteries having a terminal-to-terminal voltage of several volts, called a unit cell, are connected in series/parallel combination. With this configuration, a terminal-to-terminal voltage of each of the storage batteries 12 is set at several tens of volts, and a terminal-to-terminal voltage V_{B} of the battery assembly 14 is set at about 200 to 300V. Note that the battery assembly 14 is constituted with a plurality of storage batteries for obtaining an appropriate terminal-to-terminal voltage and a charging capacity, and substantially, the battery assembly 14 may be assumed to be a single storage battery of large capacity.

The switching unit 16 is disposed between the battery assembly 14 and the charging control unit 18 in series, and has a function for connecting or shielding between the battery assembly 14 and the charging control unit 18. As the switching unit 16, a switching element for a large current can be used. More specifically, a power MOSFET or IGBT can be used. A relay, a circuit breaker or the like may be used. The switching unit 16 is, during charging, turned on to be in a connected state basically, and it is turned off to be in a shielded state in a case where overcharging must be prevented or the like. The operation of the switching unit 16 is controlled by the battery management unit 20.

The charging control unit 18 has a function for controlling a charging current supplied to the battery assembly 14 through the switching unit 16 that is in a connected state, so that the battery assembly 14 can be fully charged in a short time with certainty. More specifically, at the start of charging, a predetermined constant current is supplied to the battery assembly 14 for performing constant current charging, and when approaching a fully charged state, the constant current charging is switched to constant voltage charging.

FIG. 2 is an explanatory set of graphs that shows a state in which the constant current charging is switched to the constant voltage charging. Since the set of graphs is intended for explanation, it is assumed that the battery assembly 14 and the charging control unit 18 are directly connected, with an internal resistance of the switching unit 16 in FIG. 1 being equal to zero.

In FIG. 2, two graphs are shown with an abscissa representing common time t. In one graph, the ordinate represents a charging current I, and in the other graph, the ordinate represents a terminal-to-terminal voltage V of the battery assembly 14. Here, charging is performed with a small current value until time t₁. This mode of charging during this period is provided to avoid suddenly performing constant current charging with a large current in an empty charge state of the battery assembly 14 in which little charging has been performed in an initial state.

When a terminal-to-terminal voltage V rises to an appropriate voltage at the time t₁, the constant current charging is started with a predetermined constant current I₀. A value of the constant current I₀ is set to be a significantly large current in order to approach a fully charged state in a short time. During the constant current charging at time t₁ or later, a charging current is kept at a constant value of I₀. As a result, with the passage of time, charging progresses in the battery assembly 14 and the terminal-to-terminal voltage V gradually rises.

Once the terminal-to-terminal voltage V reaches a predetermined voltage V₀ at time t₂, the terminal-to-terminal voltage is subsequently kept at a voltage V₀. Therefore, a current I gradually drops from the constant current I₀ and approaches zero. This period is a period of constant voltage charging. When the current I becomes almost zero at time t₃, this time point is assumed to be full charge, and charging into the battery assembly 14 ends.

In a practical sense, the switching unit 16 is connected in series between the charging control unit 18 and the battery assembly 14, and as a result, voltage drop occurs between both terminals of the switching unit 16 due to the charging current I. An issue here is whether the voltage V₀ at which switching to the constant voltage charging is performed should be compared with a terminal-to-terminal voltage V_{B} on the battery assembly 14 side of the switching unit 16 or it should be compared with a terminal-to-terminal voltage V_{A} on the charging control unit 18 side of the switching unit 16. With the assumption that R is a total resistance of an internal resistance, a wiring resistance, and the like at the switching unit 16 under a condition in which the switching unit 16 is turned on, and I is a charging current, V_{A}=V_{B}+IR, which means that V_{A} is larger than V_{B} by an amount of IR which is a voltage drop amount.

Note that the terminal-to-terminal voltage V_{A} on the charging control unit 18 side of the switching unit 16 is a voltage which the charging control unit 18 can easily acquire. Therefore, it is convenient for the charging control unit 18 to use the terminal-to-terminal voltage V_{A} for comparison with V₀, and to switch to the constant voltage charging at the time when V_{A} reaches V₀. However, in this case, switching to the constant voltage charging occurs before an actual terminal-to-terminal voltage V_{B} of the battery assembly 14 reaches V₀. As a result, time t₃ at which the battery assembly 14 reaches full charge is delayed when compared with a case in which switching to the constant voltage charging is performed at a time when V_{B} reaches V₀. This is a problem to be solved by the present invention.

To cope with this situation, the battery management unit 20 includes a voltage acquiring section 22 for acquiring the terminal-to-terminal voltage V_{B}, and a transmission processing section 24 for, when the acquired terminal-to-terminal voltage V_{B} reaches a predetermined threshold switching voltage, transmitting a switching command for prompting the charging control unit 18 to switch from constant current charging to constant voltage charging. As the threshold switching voltage, a voltage can be used which is lower than a charging upper limit voltage, being a limit under which the battery assembly 14 is not over-charged, by an amount of a predetermined marginal voltage. For compatibility with the description of FIG. 2, a description will be continued by using V₀ for the threshold switching voltage in the following.

Further, the battery management unit 20 is equipped with a charging stop processing section 26. The charging stop processing section 26 has a function to turn off the switching unit 16 when a confirmation signal about reception of the switching command is not received from the charging control unit 18 within a predetermined time period after the transmission of the switching command. For example, if switching to the constant voltage charging by the charging control unit 18 delays even when the battery management units 20 transmits the switching command, the battery assembly 14 may be over-charged. In that case, the switching unit 16 can be turned off by the function of the charging stop processing section 26.

Further, the battery management unit 20 includes a calibration voltage transmission processing section 28. The calibration voltage transmission processing section 28 has a function for acquiring the terminal-to-terminal voltage V_{B} and generating a calibration voltage for calibrating a voltage difference from the terminal-to-terminal voltage V_{A} that the charging control unit 18 can acquire, and then transmitting the calibration voltage to the charging control unit 18. In order to calibrate the terminal-to-terminal voltage V_{A} to the terminal-to-terminal voltage V_{B}, V_{B}=V_{A}−IR can be used based on the above described relational expression. In a case where R varies little in association with current, voltage, temperature, and the like, the calibration voltage can use a terminal-to-terminal voltage V_{B} at the start of charging. By doing this, the charging control unit 18 can calculate a calibrated terminal-to-terminal voltage immediately after the start of charging.

Accordingly, the charging control unit 18 can appropriately perform switching to the constant voltage charging by using the calibrated terminal-to-terminal voltage. For example, in a case where the switching command is not transmitted by accident, or transmission of the switching command is delayed because of other interrupt processing, or the like, or, even in a case where it takes time for processing after the switching command is received because of internal processing of the charging control unit 18, the charging control unit 18 can appropriately perform switching to the constant voltage charging.

The above-described battery management unit 20 can be constituted with a computer having an appropriate performance. More specifically, the battery management unit 20 is constituted with a built-in type microprocessor having an appropriate processing speed and appropriate storage capacity. The appropriate processing speed and the appropriate storage capacity mean, for example, a speed lower than the processing speed of the charging control unit 18 which is also constituted with a computer and a storage capacity of small scale, respectively. Further, each of functions of the battery management unit 20 can be realized by executing software, or more specifically, by executing a charging program. A part of such a function may be realized using hardware.

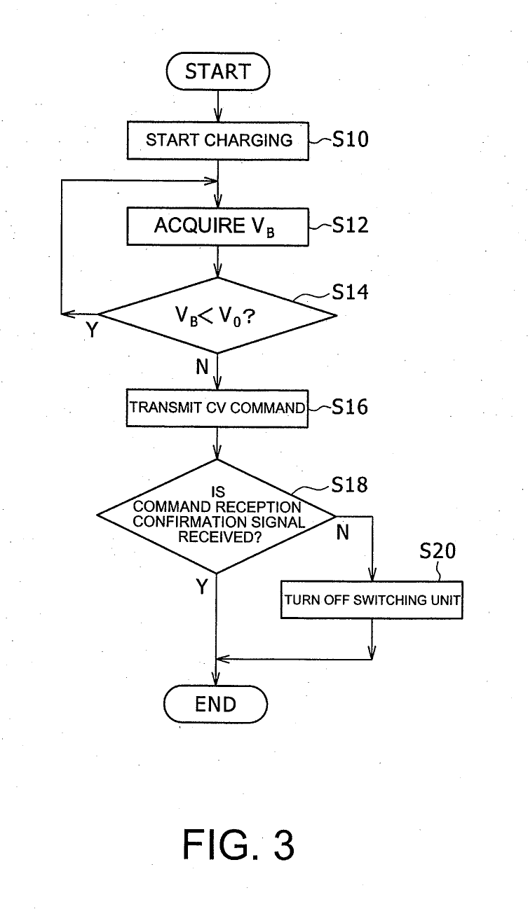

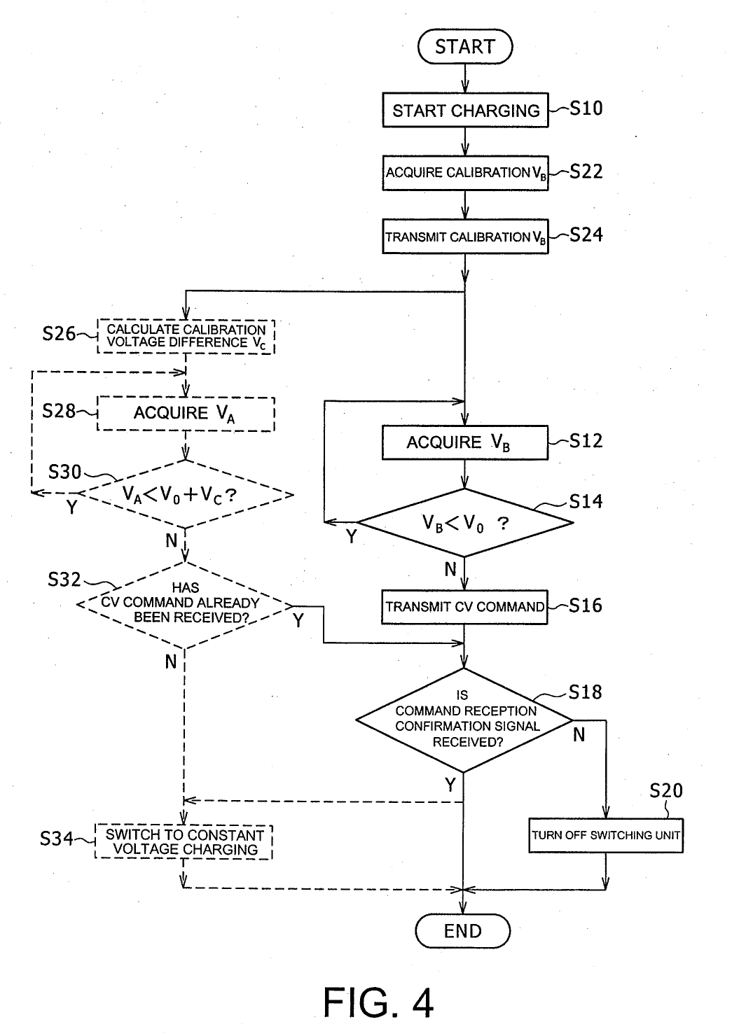

Operation of above described configuration, especially, each function of the battery management unit 20, is further described with reference to FIG. 3 and FIG. 4. FIG. 3 and FIG. 4 are flow charts showing a charging procedure. FIG. 3 is a flow chart in a case where a function of the calibration voltage transmission processing section 28 is not used, among the functions of the battery management unit 20. FIG. 4 is a flow chart in a case where the function of the calibration voltage transmission processing section 28 is also used.

In FIG. 3, when charging starts (S10), the terminal-to-terminal voltage V_{B} is acquired (S12). This step is executed by a function of the voltage acquiring section 22 of the battery management unit 20. At that time, at the charging control unit 18, control of the constant current charging described in FIG. 2 is executed.

Acquisition of the terminal-to-terminal voltage V_{B} is performed as follows. That is, at the battery assembly 14, a terminal-to-terminal voltage of each of the storage batteries 12 is detected by a voltage detector, not shown in the drawings, and is transferred to the battery management unit 20. The battery management unit 20 adds together the terminal-to-terminal voltages of the storage batteries 12 that have been transferred, to calculate and acquire a terminal-to-terminal voltage V_{B} of the battery assembly 14.

Note that the battery management unit 20 has a management function for acquiring, in addition to acquisition of a terminal-to-terminal voltage of the storage battery 12 constituting the battery assembly 14, a temperature of the storage battery 12 that is detected by a temperature detector, which is not shown in the drawings, and a current flowing through the battery assembly 14 that is detected by a current detector, not shown in the drawings. The voltage, temperature, and current that have been acquired are transmitted to a monitor unit, that is not shown in the drawings, and are utilized for charge/discharge control of the battery assembly 14.

In FIG. 3, when the terminal-to-terminal voltage V_{B} is acquired, it is compared with the threshold switching voltage V₀ (S14). Until V_{B} comes to be V₀, the process returns to S12, to continue acquisition of the terminal-to-terminal voltage V_{B}. During this period, at the charging control unit 18, control of the constant current charging is continued. When V_{B} reaches V₀, a CV command which indicates that it is a time for switching to the constant voltage charging is transmitted to the charging control unit 18 (S16). Therefore, the CV command is a switching command whose content is to cause the charging control unit 18 to perform processing of switching from the constant current charging to the constant voltage charging. The step is executed by a function of the transmission processing section 24 of the battery management unit 20.

Then, after the transmission of the CV command, it is determined whether or not a command reception confirmation signal has been received from the charging control unit 18, within a predetermined time period (S18). The length of the predetermined time period is set to just under a limit at which the battery assembly 14 is overcharged even if the constant current charging is continued. In a case where the determination of S18 is positive, switching is performed from constant current charging control to constant voltage charging control at the charging control unit 18, and a series of processes ends.

In a case where the command reception confirmation signal from the charging control unit 18 is not received within a predetermined time period and hence the determination of S18 is negative, an off-instruction is issued to the switching unit 16 in order to prevent overcharging of the battery assembly 14 (S20). As a result, shielding is performed between the charging control unit 18 and the battery assembly 14, which means charging stop processing. The step is executed by a function of a charging stop processing section 26 of the battery management unit 20.

FIG. 4 is a flow chart explaining a state in which a function of the calibration voltage transmission processing section 28 of the battery management unit 20 is also used in addition to the procedure of FIG. 3. In FIG. 4, a step indicated with a frame of a solid line is a step similar to FIG. 3, and is a step executed by the battery management unit 20. On the other hand, a step surrounded with a frame of a dashed line is a step executed by the charging control unit 18.

Here, after charging is started (S10), a calibration V_{B} is acquired (S22). Acquisition of the calibration V_{B} is, like acquisition of V_{B} in S12, to acquire the terminal-to-terminal voltage V_{B} of the battery assembly 14, but the acquired V_{B} is not used for comparison with V₀, and instead, it is used by the charging control unit 18 to calibrate the terminal-to-terminal voltage V_{A}. Therefore, the step of S22 is required to be executed before the terminal-to-terminal voltage V_{B} reaches V₀. It is preferably performed immediately after S10.

After S22, the acquired calibration V_{B} is transmitted to the charging control unit 18 (S24). The step is executed by a function of the calibration voltage transmission processing section 28 of the battery management unit 20. The processing performed by the battery management unit 20 ends with S24. Subsequently, the processing is performed by the charging control unit 18 that has received the calibration V_{B}.

At the charging control unit 18, a terminal-to-terminal voltage at the time when the calibration V_{B} is received is acquired and is used as a calibration V_{A}. Then, the calibration V_{B} and the calibration V_{A} are used to calculate a calibration voltage difference V_{C} (S26). Here, the calibration voltage difference V_{C} is calculated using V_{C}=(calibration V_{A}−calibration V_{B}).

Once V_{C} is determined, acquisition of the terminal-to-terminal voltage V_{A} is performed by the charging control unit 18 (S28). The acquired V_{A} can be calibrated using the V_{C} based on a relational expression of V_{B}=V_{A}−V_{C}. The V_{B} that is calibrated and calculated is a terminal-to-terminal voltage of the battery assembly 14 which is estimated from V_{A}. By using the estimated terminal-to-terminal voltage of the battery assembly 14, a time at which the terminal-to-terminal voltage V_{B} of the battery assembly 14 reaches V₀, can be estimated on the side of the charging control unit 18.

More specifically, the V_{A} that has been acquired is compared with (V₀+V_{C}) (S30). This process corresponds to the comparison between V_{B} and V₀ in S14, described in FIG. 3. Therefore, until V_{A} comes to be (V₀+V_{C}), the process returns to S28, and acquisition of the terminal-to-terminal voltage V_{A} is continued. During that period, at the charging control unit 18, control of the constant current charging is continued. Then, when V_{A} reaches (V₀+V_{C}), it is the time of switching to constant voltage charging.

Here, it is determined whether or not a CV command has already been received from the battery management unit 20 (S32). In a case where the CV command has already been received, the process proceeds to S18 described in FIG. 3, and after that, the process proceeds to steps S18 and S20 which are executed by the battery management unit 20.

In a case where determination of S32 is negative, since the time for switching to the constant voltage charging has already been reached, switching is performed from constant current charging control to constant voltage charging control even if the CV command is not yet received (S34).

Thus, even if reception of the CV command is delayed for some reason, by also using a function of the calibration voltage transmission processing section 28 of the battery management unit 20 at the same time, switching to control of constant voltage charging is executed appropriately. That is, according to the embodiment of the present invention as described above, when a terminal-to-terminal voltage of the storage battery in which constant current charging is being performed under the control of a charging control unit 18 reaches a predetermined threshold switching voltage, the battery management unit 20 transmits a switching command for prompting the charging control unit 18 to switch from constant current charging to constant voltage charging. With this configuration, even if an element such as a switching unit 16 is provided between the charging control unit 18 and the storage battery, the effect of voltage drop at an element such as the switch is eliminated, resulting in an appropriate time for switching from the constant current charging to the constant voltage charging.

### INDUSTRIAL APPLICABILITY

The battery management unit according to the present invention can be used for charging control of a storage battery.

### REFERENCE SIGNS LIST

10 charging system, 12 storage battery, 14 battery assembly, 16 switching unit, 18 charging control unit, 20 battery management unit, 22 voltage acquiring section, 24 transmission processing section, 26 charging stop processing section, 28 calibration voltage transmission processing section

1. A battery management unit, comprising:
a voltage acquiring section for acquiring a terminal-to-terminal voltage of a storage battery in which constant current charging is being performed under control from a charging control unit; and
a transmission processing section for, when an acquired terminal-to-terminal voltage of the storage battery reaches a predetermined threshold switching voltage, transmitting a switching command for prompting the charging control unit to switch from the constant current charging to constant voltage charging.

2. The battery management unit according to claim 1, further comprising
a calibration voltage transmission processing section which acquires the terminal-to-terminal voltage of the storage battery, generates a calibration voltage for calibrating a storage battery voltage that is acquired by adding the terminal-to-terminal voltage of the storage battery that is acquired on the charging control unit side of a switching unit provided between the charging control unit and the storage battery with a voltage drop amount at the switching unit, and transmits the calibration voltage to the charging control unit.

3. The battery management unit according to claim 2, further comprising
a charging stop processing section which turns off the switching unit when a confirmation signal about reception of the switching command is not received from the charging control unit within a predetermined time period after the transmission of the switching command.
